(19) United States
(12) Patent Application Publication
(10) Pub. No.: US 2007/0131126 A1
(43) Pub. Date: Jun. 14, 2007

(54) Method for preventing disturbances during start up and operation of a printing press

(75) Inventors: Roland Schmidberger, Meitingen/Herbertshofen (DE); August Thoma, Bonstetten (DE)

Correspondence Address: COHEN, PONTANI, LIEBERMAN & PAVANE, 551 FIFTH AVENUE, SUITE 1210, NEW YORK, NY, 10176, US

(73) Assignee: MAN Roland Druckmaschinen AG, Offenbach am Main (DE)

(21) Appl. No.: 11/638,617

(22) Filed: Dec. 13, 2006

(30) Foreign Application Priority Data
Dec. 14, 2005 (DE) 10 2005 060 190.1

(51) Int. Cl. B41F 33/00

(52) U.S. Cl. 101/484

(57) ABSTRACT

A method for preventing disturbances during the start up or operation of a printing press includes the steps of (a) detecting current measurement values for selected parameters of the printing press automatically and continuously during at least one of production start up and operation; (b) automatically comparing the current measurement values with at least one defined limit value for each parameter for the purpose of determining whether the measurement value exceeds and/or falls below a defined limit value and/or lies outside a value range defined by limit values; (c) for each current measurement value, automatically generating an alarm message and/or an operational status message based on the determination; and (d) automatically transmitting the alarm message and/or the operational status message to service devices of the printing press operator and/or the manufacturer of the printing press and/or and the supplier of the operator or manufacturer.

### BACKGROUND OF THE INVENTION

1. Field of the Invention

The invention pertains to a method for operating a printing press, especially a rotary press with rolls, namely, to a method for identifying and especially for preventively avoiding possible disturbances in production start up and/or in the operation of the printing press during the course of production.

2. Description of the Related Art

During the operation of a printing press, conditions or disturbances in the press can occur which impair the start up of the press or its operation during production and which can thus slow down the production rate or make it necessary to stop production entirely. These types of disturbances interfere with the availability of the printing press for production and reduce the interest on the capital invested in the printing press. It is therefore important to minimize production stoppages in particular and to maximize the availability of printing presses for production during the entire period of operation. It is especially important to identify as early as possible any disturbances which may develop so that they can be preventively avoided.

So far, the state of the art does not offer any methods by means of which disturbances in the start up of a printing press or in its operation during the course of production can be systematically identified for the specific purpose of preventively avoiding disturbances and thus production stoppages.

Against this background, the present invention is based on the problem of creating a novel method for operating a printing press.

### SUMMARY OF THE INVENTION

The inventive method includes at least the following steps:

(a) the current measurement values for selected parameters of the printing press are detected automatically and continuously during production start up and/or during the operation of the printing press in the course of production;

(b) the current measurement values of the detected parameters are compared automatically with at least one limit value defined for the parameter in question for the purpose of determining whether the current measurement values of the parameter exceed and/or fall below a defined limit value and/or whether these measurement values are outside a value range defined by limit values;

(c) alarm messages and/or operational status messages are generated automatically, where, when it is found that the current measurement values of a defined parameter exceed and/or fall below a defined limit value and/or are outside a value range defined by limit values and thus a disturbance in production start up or in the operation of the press in the course of production is to be expected with a defined degree of probability, an alarm message for the parameter is question is generated in an event-controlled manner, and where, when it is found that the current measurement values of the detected parameter do not exceed and/or do not fall below a defined limit value for a predefined time and/or are not outside a value range defined by limit values and thus a disturbance in production start up and/or in the operation of the press during the course of production is unlikely, an operational status message for the parameter is generated periodically;

(d) the alarm messages and/or operational status messages are transmitted automatically to service devices of the operator of the printing press and/or of the manufacturer of the printing press and/or of the operator's or manufacturer's supplier.

In accordance with the present invention, therefore, selected printing press parameters are detected automatically and continuously during the operation of the press, especially during production start up and/or the course of production operations. Current measurement values of the detected printing press parameters are compared automatically with at least one limit value, where, as a function of this comparison, alarm messages and/or operational status messages are generated automatically. These automatically generated alarm messages and/or operational status messages are sent automatically to service devices of the printing press operator and/or of the printing press manufacturer and/or of the supplier.

The present invention provides a completely new monitoring concept for printing presses, by means of which, on the basis of the continuous detection of selected printing press parameters, possible disturbances in production start up and/or in the operation of the printing press during the course of production can be detected at an early point. On the basis of the automatically transmitted alarm messages and operational status messages, service work on the printing press can be requested so promptly that production stoppages of the printing press can be avoided. As a result, the availability of the printing press for production is maximized.

According to an advantageous elaboration of the invention, after a disturbance in production start up and/or in production operations has occurred, an alarm message is generated as before, but now in addition current and/or historical measurements values of the continuously detected parameters are automatically analyzed as well, so that the disturbance which is occurring can be automatically diagnosed.

### DETAILED DESCRIPTION OF THE PRESENTLY PREFERRED EMBODIMENTS

The present invention pertains to a method for operating a printing press, especially a rotary press, namely, to a method for identifying and/or diagnosing disturbances in production start up and/or in the operation of the printing press during the course of production. In particular, the inventive method serves to preventively avoid disturbances in production start up and in the operation of the printing press during the course of production.

According to the inventive method, selected parameters of a printing press are detected automatically and continuously. These selected parameters are key parameters relevant to production, namely, parameters which are primarily responsible for slowdowns or disturbances in production start up and in the operation of the printing press during the course of production. These can be software-related or hardware-related parameters of the printing press. Examples of parameters of the printing press which can be detected continuously include printing press temperatures, paper web speeds, the rotational speeds of the cylinders or rolls of the printing press, and object-oriented software functions and run-time signals of open-loop or closed-loop printing press control devices.

According to the present invention, current measurement values of the continuously detected selected parameters are compared automatically with at least one limit value defined for the parameter in question. It is possible to check, for example, whether or not the current measurement values of the parameters exceed or fall below a defined limit. It is also possible to check whether or not the current measurements values of the parameters are outside value ranges defined by limit values.

On the basis of this automatic comparison of the current measurement values of the detected parameters with at least one limit value defined for the parameter in question, alarm messages and/or operational status messages are generated automatically. When it is found that the measurement values of a detected parameter exceed and/or fall below a defined limit and/or are outside a value range defined by limit values and thus a disturbance in production start up and/or in operation during the course of the production is to be expected with a defined degree of probability, a corresponding alarm message is generated according to the invention for the parameter in question on an event-oriented basis.

The limit values can be both manufacturer-specific and operator-specific, which means that a distinction can be made between a manufacturer-specific, event-controlled generation of alarm messages and an operator-specific, event-controlled generation of alarm messages for parameters.

When, upon comparison of the current measurement values of the automatically detected parameters with the limit values, it is found that the measurement values of a detected parameter do not exceed and/or do not fall below defined limit values for a predetermined period of time and/or are not outside a value range defined by limit values and thus a disturbance in production start up and/or in production operations is unlikely, an operational status message for the parameter is question is automatically generated periodically.

According to the invention, the automatically generated alarm messages and/or the automatically generated operational status messages are sent or transmitted automatically to service devices of the operator of the printing press and/or of the manufacture of the printing press and/or of the operator's or manufacturer's supplier. The alarm messages and/or operational status messages are preferably sent by e-mail over the Internet and/or an intranet. As a result, the agents responsible for performing service work can be informed automatically about the disturbances of the printing press which are either to be expected or are possibly occurring, so that service work can be initiated on the printing press in time and without delay. As a result, it is possible to perform maintenance work so efficiently that production stoppages during production start up and the operation of the printing press during the course of production are avoided. Abnormalities which occur during production start up and operation during the course of production can thus be identified quickly. Unplanned machine stops as a result of component failures can be effectively prevented.

According to an advantageous elaboration of the present invention, the measurement values of the continuously monitored parameters and the automatically generated alarm messages and operational status messages are automatically stored. Measurement values of the printing press parameters and alarm messages and operational status messages generated on the basis of the measurement values are archived automatically in such a way that they can be made available for analysis or diagnosis. The stored measurement values of the parameters and the alarm messages and operational status messages can be made available over the Internet or an intranet both to the operator of the printing press and to its manufacturer and supplier, so that these values and messages can be evaluated simultaneously by the operator and manufacturer and possibility also by their suppliers on different analysis and/or diagnostic systems.

Also in accordance with the present invention is the idea that, when a disturbance in production start up and/or in production operations occurs or after it has occurred, an alarm message is automatically generated and current and historical measurement values of the continuously detected parameter are automatically analyzed for the purpose of conducting an automated diagnosis of the detected disturbance. Simultaneously with the transmission of the alarm message, maintenance plans or service plans can be generated according to the invention, on the basis of which maintenance work or service work on the printing press can be performed to avoid a disturbance which might occur during production start up or operation during the course of production or to correct a problem which has already occurred.

The inventive method thus comprises four central steps, namely,

first, current measurement values of selected printing press parameters are detected automatically and continuously;

second, the current measurement values are compared automatically with at least one limit value defined for the printing press parameter in question;

third, alarm messages and/or operational status messages are generated automatically on the basis of this comparison; and

fourth, the generated alarm messages and/or operational status messages are transmitted automatically.

The inventive method is preferably applied to printing presses which offer remote access. In this case, it is then possible to use the Internet to access all of the current and historical measurement values and the alarm messages and operational status messages generated on the basis of the measurement values. In is then also possible to conduct an especially efficient analysis or diagnosis of the operation of the printing press.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for preventing disturbances during start up and operation of a printing press, said method comprising:
detecting current measurement values for selected parameters of the printing press automatically and continuously during at least one of start up and operation;
automatically comparing the current measurement values with at least one defined limit value for each said parameter;
for each said current measurement value, automatically generating at least one of an alarm message and an operational status message based on said comparing; and
automatically transmitting said at least one of an alarm message and an operational status message to at least one of service devices of the printing press operator, the manufacturer of the printing press, and the supplier of the operator or manufacturer.

2. The method of claim 1 further comprising, for each said current measure value, determining at least one of whether said measurement value exceeds a defined limit value, falls below a defined limit value, and lies outside a value range defined by limit values.

3. The method of claim 2 wherein, when it is determined that one of said measurement values exceeds a defined limit value, falls below a defined limit value, or lies outside a value range defined by limit values, thereby indicating that a disturbance during start up or operation is to be expected with a defined degree of probability, an alarm message for the corresponding parameter is generated in an event-controlled manner.

4. The method of claim 2 wherein, when it is determined that one of said measurement values does not exceed a defined limit value, fall below a defined limit value, or lie outside a value range defined by limit values, thereby indicating that a disturbance during startup or operation is unlikely, an operational status message for the corresponding parameter is generated periodically.

5. The method of claim 1 further comprising automatically storing said current measurement values and at least one of at least one said alarm message and at least one said operational status message.

6. The method of claim 3 wherein said alarm message is generated on the basis of at least one of manufacturer-specific limit values and operator-specific limit values.

7. The method of claim 1 further comprising automatically generating an alarm message after a disturbance in production start up or production operation occurs.

8. The method of claim 1 further comprising, when a disturbance in start up or operation occurs, automatically analyzing said measurement values for the purpose of diagnosing the disturbance.

9. The method of claim 1 wherein said transmitting comprises sending said at least one of an alarm message and an operational status message as e-mail over at least one of the Internet and an intranet.

10. The method of claim 1 further comprising, when an alarm message is generated, generating at least one of service instructions and maintenance instructions for correcting the corresponding disturbance.
